(19) United States
(12) Patent Application Publication
(10) Pub. No.: US 2004/0095257 A1
(43) Pub. Date: May 20, 2004

(54) High-speed analog modem

(75) Inventors: Gil Koifman, Petah Tikva (IL); Benjamin Maytal, Mevaseret Zion (IL); Tsahi Tal, Tel-Mond (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Smartlink Ltd., Netanya (IL)

(21) Appl. No.: 10/639,198

(22) Filed: Aug. 11, 2003

Related U.S. Application Data
(60) Provisional application No. 60/403,212, filed on Aug. 12, 2002.

(51) Int. Cl. G08C 19/16

(52) U.S. Cl. 340/870.21

(57) ABSTRACT

Apparatus for data communication includes a transmitter, which is adapted to generate a sequence of symbols at a variable symbol rate, responsively to a stream of digital data, and to convert the sequence to an analog data signal for transmission over a communication medium. A receiver includes an analog/digital converter (ADC), which is adapted to receive and digitize the data signal at a variable sampling rate so as to generate a sequence of digital samples, and digital processing circuitry, which is coupled to process the digital samples so as to extract the stream of digital data therefrom. The transmitter and the receiver are adapted to negotiate over the communication medium so as to set the sampling rate of the ADC and to determine the symbol rate responsively to the sampling rate.

### CROSS-REFERENCE TO RELATED APPLICATION

This application claims the benefit of U.S. Provisional Patent Application No. 60/403,212, filed Aug. 12, 2002, which incorporated herein by reference.

### FIELD OF THE INVENTION

The present invention relates generally to modems, and specifically to data modems for use over telephone lines.

### BACKGROUND OF THE INVENTION

Modems are used for transferring information between parties on communication lines or other communication media. The modem converts information from electrical signals on the communication line to a stream of data bits, and vice versa. In the past, nearly all modems used in homes and small offices operated by dial-up over telephone lines, and were therefore constrained by telephone circuitry to operate in the “voice band,” up to about 4 kHz. Standard

are therefore limited to low data rates, typically no more than 56 kbps, as specified by the ITU-T V.34, V.90 and V.92 Recommendations, for example. On account of these bandwidth and data rate limitations, voice-band modems typically sample the analog signals on the telephone line at a fixed sampling rate, generally no greater than 9.6 kHz. (This is the Nyquist sampling rate for a bandwidth of 4.8 kHz, allowing for some “spillover” of frequency components above the 4 kHz band limit.)

The V.90 Recommendation specifies the operation of a central office (CO) and customer premises equipment (CPE) modem pair for use on the Public Switched Telephone Network (PSTN). (The CO modem is referred to in the Recommendation as a “digital modem,” while the CPE modem is referred to as an “analog modem.”) The modems operate at data signaling rates of up to 56 kbps in the downstream direction (from CO to CPE) and up to 33.6 kbps in the upstream (CPE to CO) direction. Upstream operation under V.90 follows the V.34 Recommendation. The CO and CPE modems are specified by the recommendations in terms of coding, start-up signals and sequences, operating procedures and interface functionalities. Further details of V.34 and V.90 modem functions are described in ITU-T Recommendation V.34 and ITU-T Recommendation V.90, promulgated by the International Telecommunications Union (Geneva, Switzerland, 1998), which are incorporated herein by reference.

As noted above, voice-band modems are limited by the frequency constraints of the PSTN to operate at low frequencies, and therefore low symbol rates. V.34 transmission uses Quadrature Amplitude Modulation (QAM) at selectable symbol rates of 2400, 3000, and 3200 symbols/sec and optional rates of 2743, 2800 and 3429 symbols/sec. V.90 uses Pulse Code Modulation (PCM) at a fixed symbol rate of 8000 symbols/sec, to match the symbol rate and modulation scheme that are used on digital telephone trunk lines to which CO modems are commonly connected. The PCM coding scheme uses a nonlinear constellation, supporting a maximum of 256 constellation levels. Two such constellations, referred to as A-law and μ-law, are defined by the G.711 standard, referenced by the V.90 Recommendation. The number of actual data bits/symbol is configurable in a training procedure, so as to provide between a downstream data rate between 28 kbps and 56 kbps.

The functions of the CPE modem (and possibly of the CO modem, as well) may be performed either entirely by dedicated hardware or by a combination of hardware and software elements. In hardware modems, all the signal processing operations involved in extracting the data from incoming communication line signals and in generating outgoing signals to transmit data are performed by dedicated modem hardware circuits. In soft modems, some or all of these signal processing functions are performed by a host processor in a computer that is connected to the line or other media. Soft modems thus take advantage of the computational power of the host and reduce the volume and cost of hardware that is required for communications. Exemplary soft modems are described in U.S. Pat. Nos. 4,965,641 and 6,092,095, whose disclosures are incorporated herein by reference.

Recently, new types of modems have come into use, such as Digital Subscriber Line (DSL) modems, operating over wider bandwidths and offering much higher data rates over telephone lines. DSL operation, however, requires installation of special, costly hardware at both the customer premises and the central office of the telephone company.

### SUMMARY OF THE INVENTION

In embodiments of the present invention, CO and CPE modems communicate over a telephone line at enhanced symbol rates. The modems operate substantially in accordance with a voice-band communication scheme, such as that specified by the V.90 Recommendation, including features such as data coding, start-up signals and sequences, operating procedures and interface functionalities, but with increased bandwidth and certain other changes mandated by the enhanced symbol rate, as described hereinbelow. Either one of the CO and CPE modems, or both of the modems, may transmit at these enhanced rates. The enhancements of the present invention permit the modems to communicate at symbol rates and data rates in excess of the limits of 8000 symbols/sec and 56 kbps imposed by current voice band modem standards.

To accommodate the increased symbol rate, the receiving modem samples and digitizes incoming signals at a sampling rate in excess of 10 kHz. Preferably, the symbol rate and the concomitant sampling rate of the receiving modem are variable, depending on line conditions between the CO and CPE modems, as determined by negotiation between the modems during a training procedure. Additionally or alternatively, the symbol and sampling rates may be adjusted depending on resource availability, such as the availability of computing power on the host computer of a soft modem for processing the samples as they come in from the telephone line.

In some embodiments of the present invention, the rate of data communications between the CO and CPE modems is further enhanced by using a substantially linear constellation for data modulation, rather than the non-linear (PCM-compatible) constellations used in V.90 and V.92 Recommendations, complying with the G.711 standard. As a result, the sampling resolution of the modems may be more effectively exploited, using levels other than the predefined PCM levels imposed by the V.90 and V.92 recommendations, and optionally using more than 256 constellation levels.

The present invention thus provides a substantial increase in data transmission rate over voice-band modems known in the art, while taking advantage of well-defined techniques of data coding, operating procedures and interfaces that have been developed for use in existing voice-band modems (albeit at lower rates). In soft modems, for example, embodiments of the present invention may be realized simply by increasing the rate of sampling circuitry in the analog front end of the modem, with few changes in the modem software other than setting the processing speed and certain other parameter adjustments to accord with the increased sampling rate.

There is therefore provided, in accordance with an embodiment of the present invention, a data receiver, including:

an analog front end circuit, which is adapted to receive a data signal from a transmitter over a communication medium;

an analog/digital converter (ADC), which is coupled to digitize the data signal at a variable sampling rate so as to generate a sequence of digital samples; and

digital processing circuitry, which is coupled to process the digital samples so as to extract a stream of digital data therefrom, and which is adapted to negotiate with the transmitter over the communication medium so as to set the sampling rate of the ADC and to determine a variable symbol rate of the data signal responsively to the sampling rate.

In a disclosed embodiment, the communication medium includes a telephone line, and the digital processing circuitry is adapted to process the digital samples substantially in accordance with a communication scheme provided by a voice-band modem specification and to set the sampling rate to be greater than 10 kHz. Additionally or alternatively, the digital processing circuitry is adapted to negotiate with the transmitter so as to set the variable symbol rate to be substantially in excess of 8000 symbols/sec. The voice-band modem specification may be selected from among ITU-T recommendations such as V.34, V.90 and V.92. Further additionally or alternatively, the digital processing circuitry is adapted to set a variable data rate of the data signal to be in excess of 60 kbps.

In a further embodiment, the digital processing circuitry has computing resources and is adapted to determine a level of availability of the resources for processing the digital samples, and the digital processing circuitry is further adapted to negotiate with the transmitter over the communication medium so as to set the variable symbol rate responsively to the level of availability of the resources.

There is also provided, in accordance with an embodiment of the present invention, a data transmitter, including:

data modulation circuitry, which is coupled to receive a stream of digital input data and to encode the input data substantially in accordance with a communication scheme provided by a voice-band modem specification, so as to generate an output sequence of data symbols at a symbol rate substantially in excess of 8000 symbols/sec;

a digital/analog converter (DAC), which is coupled to convert the sequence of data symbols into an analog data signal; and

an analog front end circuit, which is coupled to transmit the analog data signal over a telephone line.

In a disclosed embodiment, the voice-band modem specification includes one of the V.90 and V.92 recommendations, and the data modulation circuitry is adapted to generate the output sequence of data symbols using a substantially linear constellation. Additionally or alternatively, the data modulation circuitry is adapted to generate the output sequence of data symbols using a constellation that is not a subset of pulse code modulation (PCM) constellation levels defined in a G.711 standard. Further additionally or alternatively, the data modulation circuitry is adapted to generate the output sequence of data symbols using a pulse amplitude modulation scheme allowing a constellation size of more than 256 levels.

In further embodiments, the DAC generates the analog data signal at a variable sample rate, and the data modulation circuitry is adapted to negotiate over the telephone line with a receiver of the analog data signal so as to determine the sample rate, responsively to a condition of the telephone line. Optionally, the data modulation circuitry is further adapted to apply a pre-emphasis to the data symbols, responsively to a filter characteristic selected by the receiver.

The data modulation circuitry may be adapted to determine the symbol rate further responsively to a level of availability of a communication resource of at least one of the transmitter and the receiver.

There is additionally provided, in accordance with an embodiment of the present invention, apparatus for data communication, including:

an analog front end circuit, which is adapted to receive an incoming data signal transmitted over a communication medium by a transmitter at a variable data transmission rate;

an analog/digital converter (ADC), which is coupled to digitize the incoming data signal so as to generate a sequence of digital samples; and

a computer, which has computing resources and is programmed by software instructions to process the digital samples using the computing resources so as to extract an input stream of digital data therefrom, and which is further programmed to determine a level of availability of the computing resources and to negotiate with the transmitter over the communication medium so as to determine the data transmission rate responsively to the level of availability of the resources.

Typically, the computer includes a central processing unit (CPU), and the computing resources include a processing power of the CPU. Additionally or alternatively, the computing resources include a memory.

In a disclosed embodiment, the computer is further programmed to generate digital symbols for output over the communication medium at a variable symbol rate responsively to an output stream of digital data, and to determine the symbol rate responsively to the level of availability of the resource.

Further additionally or alternatively, the data transmission rate is determined responsively to a system resource constraint of the transmitter.

There is further provided, in accordance with an embodiment of the present invention, apparatus for data communication, including:

a transmitter, which is adapted to generate a sequence of symbols at a variable symbol rate, responsively to a stream of digital data, and to convert the sequence to an analog data signal for transmission over a communication medium; and

a receiver, which includes:

an analog/digital converter (ADC), which is adapted to receive and digitize the data signal at a variable sampling rate so as to generate a sequence of digital samples; and

digital processing circuitry, which is coupled to process the digital samples so as to extract the stream of digital data therefrom,

wherein the transmitter and the receiver are adapted to negotiate over the communication medium so as to set the sampling rate of the ADC and to determine the symbol rate responsively to the sampling rate.

There is moreover provided, in accordance with an embodiment of the present invention, apparatus for data communication, including:

a transmitter, which includes:

data modulation circuitry, which is coupled to receive a stream of digital input data and to encode the input data substantially in accordance with a communication scheme provided by a voice-band modem specification, so as to generate an output sequence of data symbols at a symbol rate substantially in excess of 8000 symbols/sec;

a digital/analog converter (DAC), which is coupled to convert the sequence of data symbols into an analog data signal; and

an analog front end circuit, which is coupled to transmit the analog data signal over a telephone line; and

a receiver, which is adapted to receive the analog data signal over the telephone and to process the analog signal so as to extract the digital input data therefrom.

There is furthermore provided, in accordance with an embodiment of the present invention, apparatus for data communication, including:

a transmitter, which is adapted to generate an analog data signal, responsively to an input stream of digital data, at a variable data transmission rate for transmission over a communication medium; and

a receiver, which includes:

an analog/digital converter (ADC), which is adapted to receive and digitize the analog data signal so as to generate a sequence of digital samples; and

a computer, which has computing resources and is programmed by software instructions to process the digital samples using the computing resources so as to extract the input stream of digital data therefrom, and which is further programmed to determine a level of availability of the computing resources and to negotiate with the transmitter over the communication medium so as to determine the data transmission rate responsively to the level of availability of the resources.

There is also provided, in accordance with an embodiment of the present invention, a method for communication, including:

negotiating with a transmitter over a communication medium so as to determine a variable sampling rate of a data signal to be transmitted by the transmitter and to set a variable symbol rate of the data signal responsively to the determined sampling rate receiving the data signal from the transmitter over the communication medium;

digitizing the received data signal at the determined sampling rate so as to generate a sequence of digital samples; and

processing the digital samples so as to extract a stream of digital data therefrom.

There is additionally provided, in accordance with an embodiment of the present invention, a method for communication, including:

encoding a stream of digital input data substantially in accordance with a communication scheme provided by a voice-band modem specification, so as to generate an output sequence of data symbols at a symbol rate substantially in excess of 8000 symbols/sec;

converting the sequence of data symbols into an analog data signal; and

transmitting the analog data signal over a telephone line.

There is further provided, in accordance with an embodiment of the present invention, a method for data communication, including:

determining a level of availability of computing resources of a computer, which is programmed in software to receive and process an incoming data signal from a transmitter;

negotiating with the transmitter over a communication medium so as to determine a variable data transmission rate of the incoming data signal responsively to the level of availability of the resources;

receiving and digitizing the incoming data signal transmitted over a communication medium by the transmitter at the determined data transmission rate, so as to generate a sequence of digital samples; and

processing the digital sample using the computing resources of a computer, so as to extract an input stream of digital data therefrom.

There is moreover provided, in accordance with an embodiment of the present invention, a computer software product, including a computer-readable medium in which program instructions are stored, which instructions, when read by a computer, cause the computer to accept as input a sequence of digital samples generated responsively to a data signal received from a transmitter over a communication medium and digitized at a variable sampling rate, and cause the computer to process the digital samples so as to extract a stream of digital data therefrom,

wherein the instructions further cause the computer to negotiate with the transmitter over the communication medium so as to set the variable sampling rate and to determine a variable symbol rate of the data signal responsively to the sampling rate.

There is furthermore provided, in accordance with an embodiment of the present invention, a computer software product, including a computer-readable medium in which program instructions are stored, which instructions, when read by a computer having computing resources, cause the computer to accept as input a sequence of digital samples generated responsively to an incoming data signal transmitted over a communication medium by a transmitter at a variable data transmission rate, and to process the digital samples using the computing resources so as to extract an input stream of digital data therefrom,

wherein the instructions further cause the computer to determine a level of availability of the computing resources and to negotiate with the transmitter over the communication medium so as to determine the data transmission rate responsively to the level of availability of the resources.

There is also provided, in accordance with an embodiment of the present invention, a data transmitter, including:

data modulation circuitry, which is coupled to receive a stream of digital input data and to process the input data so as to generate an output sequence of data samples at a variable sample rate, and which is adapted to negotiate with a receiver over a communication medium so as to set the sample rate and to determine, responsively to the sample rate, a variable symbol rate of an analog data signal to be transmitted by the transmitter;

a digital/analog converter (DAC), which is coupled to convert the sequence of data samples into the analog data signal at the sample rate set by negotiation with the receiver; and

an analog front end circuit, which is coupled to transmit the analog data signal over the communication medium to the receiver.

There is additionally provided, in accordance with an embodiment of the present invention, a data receiver, including:

an analog front end circuit, which is adapted to receive a data signal from a transmitter over a communication medium;

an analog/digital converter (ADC), which is coupled to digitize the data signal at a fixed sampling rate so as to generate a sequence of digital samples; and

digital processing circuitry, which is coupled to process the digital samples so as to extract a stream of digital data therefrom, and which is adapted to negotiate with the transmitter over the communication medium so as to set a variable sample rate of the data signal and to determine a variable symbol rate of the data signal responsively to the sample rate, the digital processing circuitry including a rate converter, which is adapted to covert the sequence of samples at the fixed sampling rate to the variable sample rate prior to extraction of the digital data therefrom.

There is further provided, in accordance with an embodiment of the present invention, a data transmitter, including:

data modulation circuitry, which is coupled to receive a stream of digital input data and to process the input data so as to generate an output sequence of data samples at a variable sample rate, and which is adapted to negotiate with a receiver over a communication medium so as to set the sample rate and to determine, responsively to the sample rate, a variable symbol rate of an analog data signal to be transmitted by the transmitter, the data modulation circuitry including a rate converter, which is adapted to convert the output sequence of data samples to a predetermined, fixed sample rate;

a digital/analog converter (DAC), which is coupled to convert the output sequence of data samples into the analog data signal at the fixed sample rate; and

an analog front end circuit, which is coupled to transmit the analog data signal over the communication medium to the receiver.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a system for data communications, in accordance with an embodiment of the present invention;

FIG. 2A is a block diagram that schematically shows details of a modem, in accordance with an embodiment of the present invention;

FIG. 2B is a block diagram that schematically shows details of a modem, in accordance with another embodiment of the present invention;

FIG. 3 is a schematic spectral diagram showing an exemplary frequency band for use in data communications over a telephone line, in accordance with an embodiment of the present invention;

FIG. 4 is a schematic amplitude diagram showing constellations for data modulation, in accordance with an embodiment of the present invention; and

FIG. 5 is a flow chart that schematically illustrates a method for data communication, in accordance with an embodiment of the present invention.

### DETAILED DESCRIPTION OF EMBODIMENTS

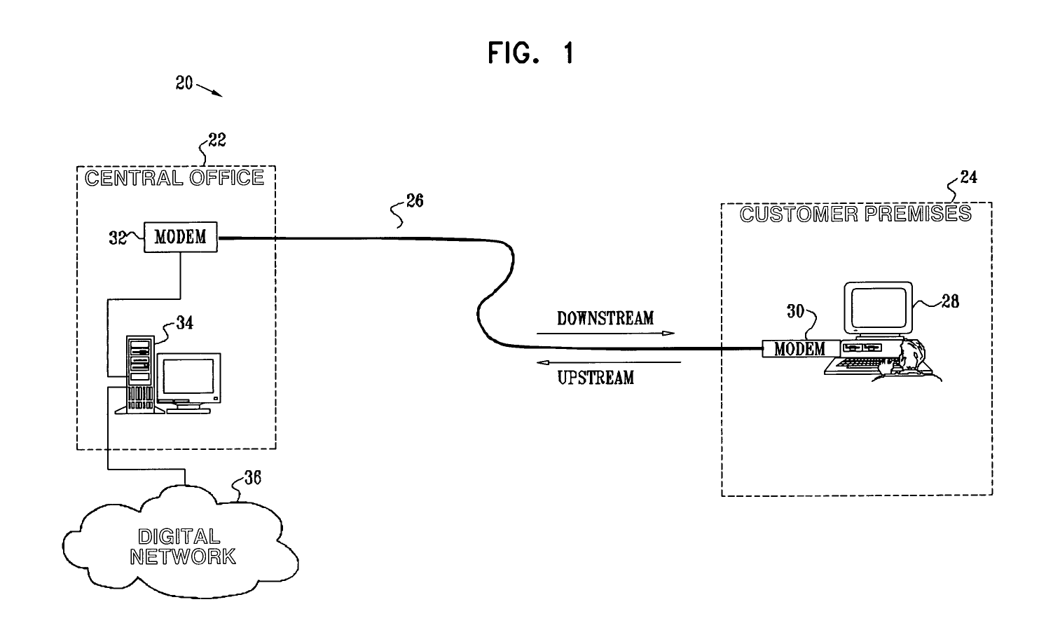

FIG. 1 is a block diagram that schematically illustrates a data communication system 20, in accordance with an embodiment of the present invention. In this embodiment, system 20 provides data communications over a telephone line 26 between a central office (CO) 22 and customer premises 24. This operating environment is described here by way of example, and the principles of the present invention may similarly be used in other applications of data communications over telephone wires and other media, as will be evident to those skilled in the art.

In customer premises 22, a computer 28 is connected via a CPE modem 30 to line 26. Modem 30 may comprise either a conventional hardware modem or a soft modem, as described in the Background of the Invention. CPE modem 30 transmits and receives analog modem signals over line 26, to and from a CO modem 32 in central office 22. CO modem 32 converts the analog modem signals to a digital data stream, and vice versa, and exchanges the digital data with a communication server 34. Server 34 is coupled to transmit and receive the data over a digital network 36, such as the Internet.

In embodiments of the present invention, modems 30 and 32 generate and decode the analog signals transmitted over line 26 using a voice-band data encoding scheme, such as that specified by the V.90 or V.92 Recommendation. According to these Recommendations, a codec in the central office, operating at the fixed rate of 8000 symbols/sec, converts PCM digital signals received over a digital telephone trunk directly into analog modem signals for transmission downstream to the CPE modem. (Alternatively, the modems may use other voice-band encoding schemes, such as the scheme specified by the V.34 Recommendation, which conventionally permits symbol rates up to 3429 symbols/sec.) In CO 22, however, modem 32 is not tied to the fixed symbol rate of the telephone trunk. Rather, modem 32 is capable of converting digital data from server 34 into downstream modem signals at an adjustable symbol rate, which may be as high as 120,000 symbols/sec. The rate of upstream transmission from modem 30 to modem 32 may similarly be accelerated. An exemplary implementation of these enhanced symbol rates is described with reference to the figures that follow.

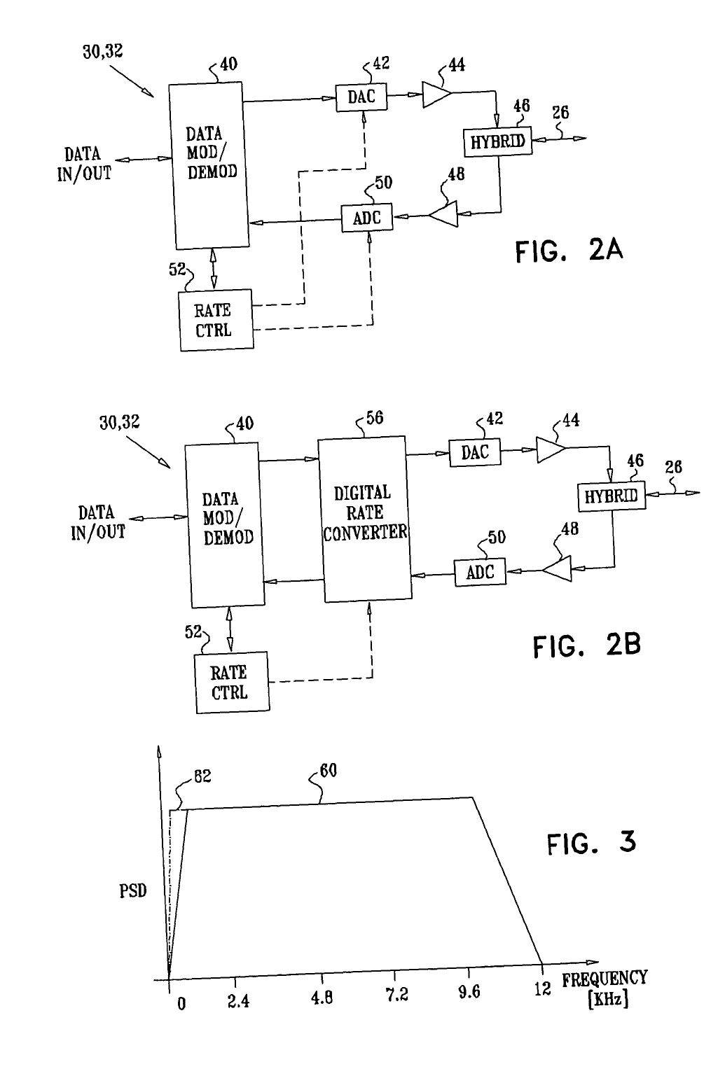

FIG. 2A is a block diagram that schematically shows details of modem 30 or 32, in accordance with an embodiment of the present invention. A digital modulator/demodulator 40 converts an input data stream for transmission over line 26 into a corresponding sequence of digital samples, in accordance with the appropriate voice-band specification, such as the V.34, V.90 or V.92 Recommendation. (V.34 is also the upstream transmission standard for V.90, while V.90 is the downstream transmission standard for V.92.) For at least the downstream link, as noted above, the digital samples correspond to symbols at a rate substantially in excess of 8000 symbols/sec. Upstream symbols may similarly be generated at this sort of accelerated rate. A digital/analog converter (DAC) 42, operating at a sample rate that is equal to or greater than the symbol rate, converts the digital samples to analog signals. The signals are amplified by an amplifier 44, and are then transmitted via a hybrid coupling circuit 46 over line 26.

Signals received by the modem over line 26 are likewise scaled by an amplifier 48, and are then digitized by an analog/digital converter (ADC) 50. ADC 50 operates at a sampling rate that is at least equal to the symbol rate of the remote transmitter at the far end of line 26, and is preferably greater than the symbol rate in order to deal with higher-frequency components on the line without aliasing. The digitized samples are input to modulator/demodulator 40, which digitally demodulates the sample sequence to recover the data stream transmitted by the remote transmitter. A rate controller 52 determines the sampling rates to be applied by DAC 42 and ADC 50. The sample and symbol rate are typically determined in a process of negotiation with the remote transmitter, as described in greater detail hereinbelow.

Assuming customer premises modem 30 to be a soft modem, the functions of modulator/demodulator 40 and rate controller 52 may be carried out in software on the CPU of computer 28. Software for this purpose may be downloaded to the computer in electronic form, over a network, for example, or it may alternatively be provided on tangible media, such as CD-ROM. Alternatively, at least some of the functions of modulator/demodulator 40 may be performed by a digital signal processor (DSP) or by dedicated digital modem hardware.

The analog hardware functions of DAC 42, ADC 50, amplifiers 44 and 48, and hybrid 46 are similar to those performed by hardware elements in existing modem front ends (in both soft modems and conventional hardware-based modems), although certain electrical parameters may be modified in accordance with the sampling frequency. In modems 30 and 32, however, these functions may be performed at a higher clock frequency—typically in excess of 10 kHz—than in voice-band modems known in the art. Furthermore, as noted above, the clock frequency of the analog hardware in modem 30 and/or 32 may be varied under the control of rate controller 52.

FIG. 2B is a block diagram that schematically shows details of modem 30 or 32, in accordance with an alternative embodiment of the present invention. The implementation shown in this figure is similar to that shown in FIG. 2A and described with reference thereto, except that in the modem of FIG. 2B, ADC 50 and DAC 42 are capable of operating only at a fixed sampling rate. In this case, a digital rate converter 56, which is controlled by rate controller 52, is responsible for rate adaptation of the incoming and outgoing samples.

FIG. 3 is a schematic spectral diagram showing an exemplary frequency band 60 used in data communication between modems 32 and 30, in accordance with an embodiment of the present invention. Although band 60 in this example is limited to the range below 12 kHz, it is also possible to use a much broader band, such as 60 kHz for example. For the sake of simplicity, the use of band 60 is described here with reference to downstream transmission, but it will be understood that an expanded transmission band of this sort may likewise be used in upstream transmission. In this example, modulator/demodulator 40 of modem 32 generates digital samples at a symbol rate of 20,000 symbols/sec, 2.5 times the V.90 symbol rate. In practice, under good line conditions, it is possible to increase the symbol rate up to fifteen-fold, i.e., to 120,000 symbols/sec.

To accommodate this high symbol rate, DAC 42 in modem 32 operates at a sample rate of at least 20,000 samples/sec, giving a transmission bandwidth of 10 kHz, as opposed to the 4 kHz limit of conventional voice-band modems. Because of non-ideal filtering, however, band 60 typically includes frequency components above the 10 kHz limit, extending up to 12 kHz in the present example. To deal with this bandwidth “spillover,” as noted above, ADC 50 in modem 30 preferably samples the downstream signal at a sampling rate of at least 24 kHz.

The V.90 Recommendation allows for spectral shaping to be employed to help the customer premises modem combat the distorting effects of the transformers and filters used in its D/A conversion of downstream signals. The customer premises modem chooses the shaping function to be used and informs the central office modem of its choice during the training sequence, before regular data communication begins. Typically, the shaping reduces the power spectral density (PSD) of transmission in the low-frequency range, below about 150 Hz, at the expense of reduced data transmission rate.

Band 60 in FIG. 3 shows the effect of spectral shaping in the range of frequencies below about 1 kHz. Alternatively, shaping may be disabled, as shown by a band 62, which has stronger low-frequency components. Both of bands 60 and 62 are “stretched” by the increased sample rate of modem 32, relative to the comparable shaped and unshaped bands generated by a conventional voice-band modem. Therefore, in system 20, band 62 may provide sufficient suppression of low frequencies to avoid distortion, so that the shaping function may be disabled, or at least moderated. The use of band 62 in this manner provides added data rate enhancement, in addition to the direct enhancement of data rate due to the increased symbol rate of modem 32.

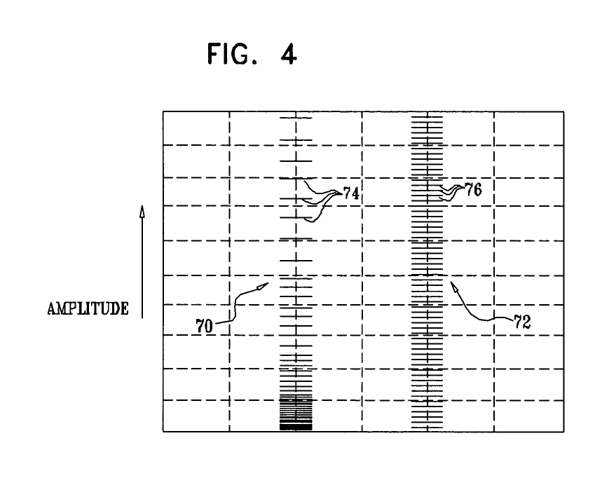

FIG. 4 is a schematic amplitude diagram showing data modulation constellations 70 and 72. For convenience, only positive levels of the constellation are shown in the figure, although the full constellation also includes the negative replicas of these levels. Constellation 70 is a conventional μ-law constellation, as specified by the V.90 Recommendation (referencing the G.711 standard), with constellation levels 74 whose separation increases in a strongly non-linear fashion—roughly logarithmically—with increasing amplitude. As noted above, V.90 constellations must accord with non-linear PCM encoding and therefore are limited to a subset of 256 possible PCM levels. In practice, the minimum separation between closely-spaced low-amplitude levels (referred to as dₘᵢₙ) may be limited by line conditions, so that effectively fewer than 256 levels are available between the minimum and maximum amplitude levels. In such cases, V.90 modems must reduce the number of bits/symbol that they transmit.

Constellation 72 is a linear constellation that may be used in system 20, in accordance with an embodiment of the present invention. Modem 32 is not constrained to interface with a PCM digital telephone trunk, and therefore can use substantially any suitable constellation. In constellation 72, levels 76 are spaced linearly over the available amplitude range. It can be seen that for a given dₘᵢₙ, the linear constellation permits a greater number of constellation levels to be used than can be provided by non-linear constellations. Linear constellation 72 gives optimal immunity to the effects of additive white Gaussian noise (AWGN) and permits significantly more constellation levels to be used, and hence allows more bits per symbol to be transmitted, as opposed to the non-linear μ-law and A-law based constellations. Thus, the enhancement of data rate due to operating modems 30 and 32 at increased speed may be effectively doubled under good line conditions by use of constellation 72.

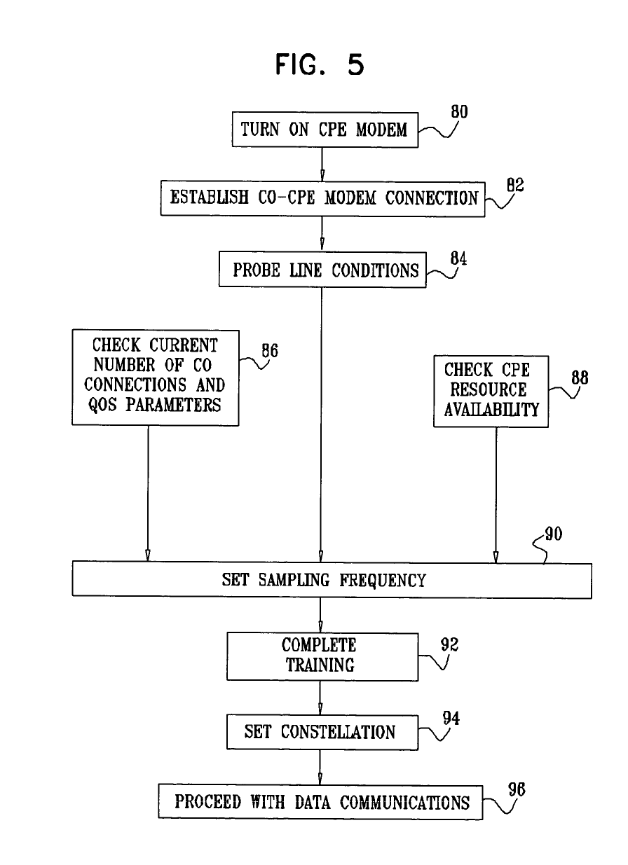

FIG. 5 is a flow chart that schematically illustrates a method for operating system 20, in accordance with an embodiment of the present invention. The method is typically initiated when customer premises modem 30 is turned on, at a start-up step 80. Modem 30 then establishes an initial connection with modem 32, at a connection step 82. For this purpose, modem 30 may dial up to modem 32, as in voice-band modems known in the art. Dial-up operation is described in the above-mentioned ITU-T Recommendations. Alternatively, line 26 may be used as a dedicated modem line, in which case modem 32 is “always on,” and no dial-up is required. In this case, modem 32 transmits a sync signal (ID_SIG_{CO}) continuously, while waiting for modem 30 to start up. Upon detecting the ID_SIG_{CO} signal, modem 30 responds by transmitting its own upstream identification signal ID_SIG_{CPE}. When modem 32 detects ID_SIG_{CPE}, it terminates ID_SIG_{CO}, following which modem 30 likewise terminates ID_SIG_{CPE}. After the subsequent communication session is terminated, modem 32 resumes transmission of ID_SIG_{CO}, waiting for modem 30 to re-initiate communications.

Both of modems 30 and 32 maintain a brief period of silence after terminating their respective identification signals, and then begin to probe the condition of line 26, at a line probing step 84. The object of this step is to determine the maximal “acceleration factor,” i.e., to determine the highest possible sampling rate at which the modems will be able to run. For this purpose, modems 30 and 32 send probing signals, such as a frequency comb, several carriers or white noise, one to the other across the potential frequency band. Based on the quality of the received signals at the various frequencies, the maximum sampling frequency can be selected. Note that different sampling frequencies may be used for receive and transmit. Other considerations may also be taken into account in the selection of the sampling frequency and the frequency band to be used (as described below at steps 86 and 88, for example).

After the sampling frequency has been set, the modems enter “Phase 2” of their start-up sequence, to determine the connection bit rate. This phase conforms generally to the corresponding phase in the start-up sequence of conventional voice-band modems, such as the corresponding phase specified by the V.34 and V.90 Recommendations. Certain features defined by the standard voice-band modem specifications, however, such as state durations, signal durations and timeout periods, are preferably adjusted in this and subsequent phases of the training procedure to accommodate the increased symbol rate and sampling frequency used in system 20. For example, the number of symbols per state may be extended by the acceleration factor, taking into account modulation restrictions (such as the restriction in V.90 that the number of symbols per state is a multiple of 6).

As noted above, Phase 2 includes transmission and reception of training signals between modems 30 and 32 in order to determine the condition of line 26. Typically, in conventional voice-band modems, the training signals include two line probing signals, L1 and L2, which consist of a set of tones (cosines) spaced 150 Hz apart at frequencies from 150 Hz to 3750 Hz. In system 20, the tones are stretched based on the acceleration factor (so that if the acceleration factor is 2, for example, the tones will run from 300 Hz to 7500 Hz). Optionally, the probing signals may be extended to cover the full frequency band that may be used for transmission. The amplitude of the training signals may also be increased, relative to the levels given by the V.34 Recommendation, in order to facilitate establishment of connections over very long reaches of line 26, in which the ratio of echo-to-signal is very high.

Modems 30 and 32 typically use INFO sequences, which are also specified by the V.34 Recommendation, to exchange capabilities information and modulation parameters, based on line probing. Typically, if difficulties are encountered in establishing communications between the modems, the modems may use the INFO₀ recovery procedure provided by the V.34 Recommendation. When system 20 operates at a high sampling rate over a long reach, such difficulties may occur frequently. Therefore, the INFO₀ recovery mechanism may be used from the start of communications, thus avoiding the long wait period that commonly ensues when actual difficulties occur.

In setting the symbol rate at which modems 30 and 32 are to communicate, rate controllers 52 (FIG. 2) may take into account not only the line conditions determined at step 84, but also the availability of other system resources. For this purpose, rate controller 52 in central office 22 may check system resource constraints of the central office, including factors, for example, such as quality of service (QoS) parameters and the number of active customer connections being served by the central office, at a CO resource checking step 86. If other CO modems (particularly modems in the same rack) are already servicing active connections, the sustainable symbol rate of a new connection may be limited by crosstalk between the modems or by data switching or processing capacity of server 34. The QoS parameters may indicate, for example, the minimum and excess communication bit rates to which each customer is entitled. Central office 22 may take these factors into account in setting maximum and minimum symbol rates for each connection.

Rate controller 52 of modem 30 may also check the resources available for the current communication session in customer premises 24, at a CPE resource checking step 88. For example, if modem 30 is a soft modem, the rate at which the modem can operate may be limited by the availability of resources on computer 28. If the CPU of the computer is simultaneously busy with other tasks, or the computer is short on memory, the computer may not be able to keep up with the maximum symbol rate that line 26 can support. In this case, controller 52 of modem 30 may choose a symbol rate that is lower than this maximum. Note that this novel use of resource availability as a factor in determining data transmission rates is applicable not only in the context of voice-band modems, but also in controlling modems of other types, as will be apparent to those skilled in the art. Modems 30 and 32 exchange the information collected at steps 84, 86 and 88, and use the information to determine the symbol rates and sampling frequencies to be applied in communications over line 26, at a rate setting step 90. Typically, the symbol rates are set to the highest values that can reliably be sustained given the existing line conditions and resource availability. Subsequently, during data communications, the modems may periodically probe the line and resource availability, and may then increase or decrease the symbol rate as appropriate.

In addition to determining the sampling and symbol rates, modems 30 and 32 use the information they have gathered on line condition to set certain communication parameters, at a training completion step 92. Optionally, data modulator/demodulator 40 comprises a digital pre-emphasis filter, for spectral shaping of transmitted signals. Pre-emphasis is particularly useful in system 20 in order to compensate for increased distortion in the signal envelope that may come with increased bandwidth, relative to the distortion encountered by conventional voice-band modems. Typically, modem 30 chooses the pre-emphasis filter characteristic to be applied by modem 32 based on the results of line probing at steps 84 or 92 or both. The filter characteristic may be selected from a set of predefined filters, or they may alternatively be dynamically defined based on the probing results. Other parameters that may be set at step 92 include, for example, the transmit power level, adaptation factors, and echo cancellation and equalization settings.

After choosing the sample and symbol rate and communication parameters, modems 30 and 32 exchange a further sequence of training signals in order to negotiate the symbol constellation that they are to use, at a constellation setting step 94, thus determining the bit rate. Preferably, a linear constellation is selected, as shown in FIG. 4, although other constellation types may alternatively be used if appropriate. In general, the receiving modem in each direction (upstream and downstream) selects the constellation and then conveys the constellation parameters to the transmitting modem. Optionally, for a linear constellation, it is sufficient for the receiving modem to give the transmitting modem the values of dₘᵢₙ (the constellation level spacing) and the number of constellation points.

After completing the training sequence at step 94, modems 30 and 32 begin normal data communications, at a communication step 96. Notwithstanding the increase in the symbol rate and in the constellation size, the basic data modulation and demodulation algorithms defined by the applicable voice-band modem specification may still be applied, largely without change. A number of modulation parameters should be adjusted for the enhanced transmission rate, such as K (the number of modulus encoder input data bits per data frame) and D (the maximal rate index) of the V.90 Recommendation.

Although the embodiments described above are directed to communication over telephone lines and make reference to particular voice-band modem standards, certain principles of the present invention may similarly be applied in other types of data modems, for use over both telephone lines and other communication media. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A data receiver, comprising:
an analog front end circuit, which is adapted to receive a data signal from a transmitter over a communication medium;
an analog/digital converter (ADC), which is coupled to digitize the data signal at a variable sampling rate so as to generate a sequence of digital samples; and
digital processing circuitry, which is coupled to process the digital samples so as to extract a stream of digital data therefrom, and which is adapted to negotiate with the transmitter over the communication medium so as to set the sampling rate of the ADC and to determine a variable symbol rate of the data signal responsively to the sampling rate.

2. The receiver according to claim 1, wherein the communication medium comprises a telephone line, and wherein the digital processing circuitry is adapted to process the digital samples substantially in accordance with a communication scheme provided by a voice-band modem specification and to set the sampling rate to be greater than 10 kHz.

3. The receiver according to claim 1, wherein the communication medium comprises a telephone line, and wherein the digital processing circuitry is adapted to process the digital samples substantially in accordance with a communication scheme provided by a voice-band modem specification and to negotiate with the transmitter so as to set the variable symbol rate to be substantially in excess of 8000 symbols/sec.

4. The receiver according to claim 3, wherein the voice-band modem specification is selected from among ITU-T recommendations V.34, V.90 and V.92.

5. The receiver according to claim 1, wherein the communication medium comprises a telephone line, and wherein the digital processing circuitry is adapted to process the digital samples substantially in accordance with a communication scheme provided by a voice-band modem specification and to negotiate with the transmitter so as to set a variable data rate of the data signal to be in excess of 60 kbps.

6. The receiver according to claim 1, wherein the digital processing circuitry has computing resources and is adapted to determine a level of availability of the resources for processing the digital samples, and wherein the digital processing circuitry is further adapted to negotiate with the transmitter over the communication medium so as to set the variable symbol rate responsively to the level of availability of the resources.

7. A data transmitter, comprising:
data modulation circuitry, which is coupled to receive a stream of digital input data and to encode the input data substantially in accordance with a communication scheme provided by a voice-band modem specification, so as to generate an output sequence of data symbols at a symbol rate substantially in excess of 8000 symbols/sec;
a digital/analog converter (DAC), which is coupled to convert the sequence of data symbols into an analog data signal; and
an analog front end circuit, which is coupled to transmit the analog data signal over a telephone line.

8. The transmitter according to claim 7, wherein the data modulation circuitry is adapted to generate the output sequence of data symbols so that the data signal has a data rate substantially in excess of 60 kbps.

9. The transmitter according to claim 7, wherein the voice-band modem specification is selected from among ITU-T recommendations V.34, V.90 and V.92.

10. The transmitter according to claim 9, wherein the voice-band modem specification comprises one of the V.90 and V.92 recommendations, and wherein the data modulation circuitry is adapted to generate the output sequence of data symbols using a substantially linear constellation.

11. The transmitter according to claim 9, wherein the voice-band modem specification comprises one of the V.90 and V.92 recommendations, and wherein the data modulation circuitry is adapted to generate the output sequence of data symbols using a constellation that is not a subset of pulse code modulation (PCM) constellation levels defined in a G.711 standard.

12. The transmitter according to claim 9, wherein the data modulation circuitry is adapted to generate the output sequence of data symbols using a pulse amplitude modulation scheme allowing a constellation size of more than 256 levels.

13. The transmitter according to claim 7, wherein the DAC generates the analog data signal at a variable sample rate, and wherein the data modulation circuitry is adapted to negotiate over the telephone line with a receiver of the analog data signal so as to determine the sample rate, responsively to a condition of the telephone line.

14. The transmitter according to claim 13, wherein the data modulation circuitry is further adapted to apply a pre-emphasis to the data symbols, responsively to a filter characteristic selected by the receiver.

15. The transmitter according to claim 13, wherein the data modulation circuitry is adapted to determine the symbol rate further responsively to a level of availability of a communication resource of at least one of the transmitter and the receiver.

16. Apparatus for data communication, comprising:
an analog front end circuit, which is adapted to receive an incoming data signal transmitted over a communication medium by a transmitter at a variable data transmission rate;
an analog/digital converter (ADC), which is coupled to digitize the incoming data signal so as to generate a sequence of digital samples; and
a computer, which has computing resources and is programmed by software instructions to process the digital samples using the computing resources so as to extract an input stream of digital data therefrom, and which is further programmed to determine a level of availability of the computing resources and to negotiate with the transmitter over the communication medium so as to determine the data transmission rate responsively to the level of availability of the resources.

17. The apparatus according to claim 16, wherein the computer comprises a central processing unit (CPU), and wherein the computing resources comprise a processing power of the CPU.

18. The apparatus according to claim 16, wherein the computing resources comprise a memory.

19. The apparatus according to claim 16, wherein the computer is further programmed to generate digital symbols for output over the communication medium at a variable symbol rate responsively to an output stream of digital data, and to determine the symbol rate responsively to the level of availability of the resource.

20. The apparatus according to claim 16, wherein the data transmission rate is determined further responsively to a system resource constraint of the transmitter.

21. Apparatus for data communication, comprising:
a transmitter, which is adapted to generate a sequence of symbols at a variable symbol rate, responsively to a stream of digital data, and to convert the sequence to an analog data signal for transmission over a communication medium; and
a receiver, which comprises:
an analog/digital converter (ADC), which is adapted to receive and digitize the data signal at a variable sampling rate so as to generate a sequence of digital samples; and
digital processing circuitry, which is coupled to process the digital samples so as to extract the stream of digital data therefrom,
wherein the transmitter and the receiver are adapted to negotiate over the communication medium so as to set the sampling rate of the ADC and to determine the symbol rate responsively to the sampling rate.

22. The apparatus according to claim 21, wherein the communication medium comprises a telephone line, and wherein the transmitter is adapted to generate the sequence of symbols substantially in accordance with a communication scheme provided by a voice-band modem specification, and wherein the receiver is adapted to set the sampling rate to be greater than 10 kHz.

23. The apparatus according to claim 21, wherein the communication medium comprises a telephone line, and wherein the transmitter is adapted to generate the sequence of symbols substantially in accordance with a communication scheme provided by a voice-band modem specification, while setting the variable symbol rate to be substantially in excess of 8000 symbols/sec.

24. The apparatus according to claim 23, wherein the voice-band modem specification is selected from among ITU-T recommendations V.34, V.90 and V.92.

25. The apparatus according to claim 21, wherein the communication medium comprises a telephone line, and wherein the transmitter is adapted to generate the sequence of symbols substantially in accordance with a communication scheme provided by a voice-band modem specification, so that the analog data signal has a data rate in excess of 60 kbps.

26. The apparatus according to claim 21, wherein the receiver has computing resources and is adapted to determine a level of availability of the resources for processing the digital samples, and wherein the receiver is further adapted to negotiate with the transmitter over the communication medium so as to set the variable symbol rate responsively to the level of availability of the resources.

27. Apparatus for data communication, comprising:
a transmitter, which comprises:
data modulation circuitry, which is coupled to receive a stream of digital input data and to encode the input data substantially in accordance with a communication scheme provided by a voice-band modem specification, so as to generate an output sequence of data symbols at a symbol rate substantially in excess of 8000 symbols/sec;
a digital/analog converter (DAC), which is coupled to convert the sequence of data symbols into an analog data signal; and
an analog front end circuit, which is coupled to transmit the analog data signal over a telephone line; and
a receiver, which is adapted to receive the analog data signal over the telephone and to process the analog signal so as to extract the digital input data therefrom.

28. The apparatus according to claim 27, wherein the data modulation circuitry is adapted to generate the output sequence of data symbols so that the data signal has a data rate substantially in excess of 60 kbps.

29. The apparatus according to claim 27, wherein the voice-band modem specification is selected from among ITU-T recommendations V.34, V.90 and V.92.

30. The apparatus according to claim 29, wherein the voice-band modem specification comprises one of the V.90 and V.92 recommendations, and wherein the data modulation circuitry is adapted to generate the output sequence of data symbols using a substantially linear constellation.

31. The apparatus according to claim 29, wherein the voice-band modem specification comprises one of the V.90 and V.92 recommendations, and wherein the data modulation circuitry is adapted to generate the output sequence of data symbols using a constellation that is not a subset of pulse code modulation (PCM) constellation levels defined in a G.711 standard.

32. The apparatus according to claim 29, wherein the data modulation circuitry is adapted to generate the output sequence of data symbols using a pulse amplitude modulation scheme allowing a constellation size of more than 256 levels.

33. The apparatus according to claim 27, wherein the DAC generates the analog data signal at a variable sample rate, and wherein the transmitter and receiver are adapted to negotiate over the telephone line so as to determine the sample rate, responsively to a condition of the telephone line.

34. The apparatus according to claim 33, wherein the data modulation circuitry is adapted to apply a pre-emphasis to the data symbols, responsively to a filter characteristic selected by the receiver.

35. The apparatus according to claim 33, wherein the transmitter and receiver are adapted to determine the symbol rate further responsively to a level of availability of a communication resource of at least one of the transmitter and the receiver.

36. Apparatus for data communication, comprising:
a transmitter, which is adapted to generate an analog data signal, responsively to an input stream of digital data, at a variable data transmission rate for transmission over a communication medium; and
a receiver, which comprises:
an analog/digital converter (ADC), which is adapted to receive and digitize the analog data signal so as to generate a sequence of digital samples; and
a computer, which has computing resources and is programmed by software instructions to process the digital samples using the computing resources so as to extract the input stream of digital data therefrom, and which is further programmed to determine a level of availability of the computing resources and to negotiate with the transmitter over the communication medium so as to determine the data transmission rate responsively to the level of availability of the resources.

37. The apparatus according to claim 36, wherein the computer comprises a central processing unit (CPU), and wherein the computing resources comprise a processing power of the CPU.

38. The apparatus according to claim 36, wherein the computing resources comprise a memory.

39. The apparatus according to claim 36, wherein the computer is further programmed to generate digital symbols for output over the communication medium at a variable symbol rate responsively to an output stream of digital data, and to determine the symbol rate responsively to the level of availability of the resource.

40. The apparatus according to claim 36, wherein the data transmission rate is determined further responsively to a system resource constraint of the transmitter.

41. A method for communication, comprising:
negotiating with a transmitter over a communication medium so as to determine a variable sampling rate of a data signal to be transmitted by the transmitter and to set a variable symbol rate of the data signal responsively to the determined sampling rate receiving the data signal from the transmitter over the communication medium;
digitizing the received data signal at the determined sampling rate so as to generate a sequence of digital samples; and
processing the digital samples so as to extract a stream of digital data therefrom.

42. The method according to claim 41, wherein the communication medium comprises a telephone line, and wherein negotiating with the transmitter comprises setting the variable sampling rate to be greater than 10 kHz, and
wherein processing the digital samples comprises decoding the samples substantially in accordance with a communication scheme provided by a voice-band modem specification.

43. The method according to claim 41, wherein the communication medium comprises a telephone line, and wherein negotiating with the transmitter comprises setting the variable symbol rate to be substantially in excess of 8000 symbols/sec, and
wherein processing the digital samples comprises decoding the samples substantially in accordance with a communication scheme provided by a voice-band modem specification.

44. The method according to claim 43, wherein the voice-band modem specification is selected from among ITU-T recommendations V.34, V.90 and V.92.

45. The method according to claim 41, wherein the communication medium comprises a telephone line, and wherein negotiating with the transmitter comprises setting a variable data rate of the data signal to be in excess of 60 kbps, and
wherein processing the digital samples comprises decoding the samples substantially in accordance with a communication scheme provided by a voice-band modem specification.

46. The method according to claim 41, wherein negotiating with the transmitter comprises determining a level of availability of resources for processing the digital samples, and setting the variable symbol rate responsively to the level of availability of the resources.

47. A method for communication, comprising:
encoding a stream of digital input data substantially in accordance with a communication scheme provided by a voice-band modem specification, so as to generate an output sequence of data symbols at a symbol rate substantially in excess of 8000 symbols/sec;
converting the sequence of data symbols into an analog data signal; and
transmitting the analog data signal over a telephone line.

48. The method according to claim 47, wherein encoding the stream of digital input data comprises generating the output sequence of data symbols at a data rate substantially in excess of 60 kbps.

49. The method according to claim 47, wherein the voice-band modem specification is selected from among ITU-T recommendations V.34, V.90 and V.92.

50. The method according to claim 49, wherein the voice-band modem specification comprises one of the V.90 and V.92 recommendations, and wherein encoding the stream of digital input data comprises generating the output sequence of data symbols using a substantially linear constellation.

51. The method according to claim 49, wherein the voice-band modem specification comprises one of the V.90 and V.92 recommendations, and wherein encoding the stream of digital input data comprises generating the output sequence of data symbols using a constellation that is not a subset of pulse code modulation (PCM) constellation levels defined in a G.711 standard.

52. The method according to claim 49, wherein encoding the stream of digital input data comprises generating the output sequence of data symbols using a pulse amplitude modulation scheme allowing a constellation size of more than 256 levels.

53. The method according to claim 47, and comprising negotiating over the telephone line with a receiver of the analog data signal so as to determine a sample rate for converting the sequence of data symbols into the analog data signal, responsively to a condition of the telephone line.

54. The method according to claim 53, wherein encoding the stream of digital input data comprises applying a pre-emphasis to the data symbols, responsively to a filter characteristic selected by the receiver.

55. The method according to claim 53, wherein negotiating with the receiver comprises determining the symbol rate further responsively to a level of availability of a communication resource used in the communication.

56. A method for data communication, comprising:
determining a level of availability of computing resources of a computer, which is programmed in software to receive and process an incoming data signal from a transmitter;
negotiating with the transmitter over a communication medium so as to determine a variable data transmission rate of the incoming data signal responsively to the level of availability of the resources;
receiving and digitizing the incoming data signal transmitted over a communication medium by the transmitter at the determined data transmission rate, so as to generate a sequence of digital samples; and
processing the digital sample using the computing resources of a computer, so as to extract an input stream of digital data therefrom.

57. The method according to claim 56, wherein the computer comprises a central processing unit (CPU), and wherein the computing resources comprise a processing power of the CPU.

58. The method according to claim 56, wherein the computing resources comprise a memory of the computer.

59. The method according to claim 56, and comprising determining, responsively to the level of availability of the resource, a symbol rate of an outgoing data signal to by generated by the computer using the computing resources, and generating the outgoing data signal for output over the communication medium at the determined symbol rate responsively to an output stream of digital data.

60. The method according to claim 56, wherein negotiating with the transmitter comprises determining the data transmission rate further responsively to a system resource constraint of the transmitter.

61. A computer software product, comprising a computer-readable medium in which program instructions are stored, which instructions, when read by a computer, cause the computer to accept as input a sequence of digital samples generated responsively to a data signal received from a transmitter over a communication medium and digitized at a variable sampling rate, and cause the computer to process the digital samples so as to extract a stream of digital data therefrom,
wherein the instructions further cause the computer to negotiate with the transmitter over the communication medium so as to set the variable sampling rate and to determine a variable symbol rate of the data signal responsively to the sampling rate.

62. The product according to claim 61, wherein the communication medium comprises a telephone line, and wherein the instructions cause the computer to process the digital samples substantially in accordance with a communication scheme provided by a voice-band modem specification and to negotiate with the transmitter so as to set the variable sampling rate to be greater than 10 kHz.

63. The product according to claim 61, wherein the communication medium comprises a telephone line, and wherein the instructions cause the computer to process the digital samples substantially in accordance with a communication scheme provided by a voice-band modem specification and to negotiate with the transmitter so as to set the variable symbol rate to be substantially in excess of 8000 symbols/sec.

64. The product according to claim 63, wherein the voice-band modem specification is selected from among ITU-T recommendations V.34, V.90 and V.92.

65. The product according to claim 61, wherein the communication medium comprises a telephone line, and wherein the instructions cause the computer to process the digital samples substantially in accordance with a communication scheme provided by a voice-band modem specification and to negotiate with the transmitter so as to set a data rate of the data signal to be in excess of 60 kbps.

66. The product according to claim 61, wherein the computer has computing resources, and wherein the instructions cause the computer to determine a level of availability of the resources for processing the digital samples, and to negotiate with the transmitter over the communication medium so as to set the variable symbol rate responsively to the level of availability of the resources.

67. A computer software product, comprising a computer-readable medium in which program instructions are stored, which instructions, when read by a computer having computing resources, cause the computer to accept as input a sequence of digital samples generated responsively to an incoming data signal transmitted over a communication medium by a transmitter at a variable data transmission rate, and to process the digital samples using the computing resources so as to extract an input stream of digital data therefrom,
wherein the instructions further cause the computer to determine a level of availability of the computing resources and to negotiate with the transmitter over the communication medium so as to determine the data transmission rate responsively to the level of availability of the resources.

68. The product according to claim 67, wherein the computer comprises a central processing unit (CPU), and wherein the computing resources comprise a processing power of the CPU.

69. The product according to claim 67, wherein the computing resources comprise a memory of the computer.

70. The product according to claim 67, wherein the instructions further cause the computer to generate digital symbols for output over the communication medium at a variable symbol rate responsively to an output stream of digital data, and to determine the symbol rate responsively to the level of availability of the resource.

71. The product according to claim 67, wherein the instructions cause the computer to determine the data transmission rate further responsively to a system resource constraint of the transmitter.

72. A data transmitter, comprising:
data modulation circuitry, which is coupled to receive a stream of digital input data and to process the input data so as to generate an output sequence of data samples at a variable sample rate, and which is adapted to negotiate with a receiver over a communication medium so as to set the sample rate and to determine, responsively to the sample rate, a variable symbol rate of an analog data signal to be transmitted by the transmitter;
a digital/analog converter (DAC), which is coupled to convert the sequence of data samples into the analog data signal at the sample rate set by negotiation with the receiver; and
an analog front end circuit, which is coupled to transmit the analog data signal over the communication medium to the receiver.

73. A data receiver, comprising:
an analog front end circuit, which is adapted to receive a data signal from a transmitter over a communication medium;
an analog/digital converter (ADC), which is coupled to digitize the data signal at a fixed sampling rate so as to generate a sequence of digital samples; and
digital processing circuitry, which is coupled to process the digital samples so as to extract a stream of digital data therefrom, and which is adapted to negotiate with the transmitter over the communication medium so as to set a variable sample rate of the data signal and to determine a variable symbol rate of the data signal responsively to the sample rate, the digital processing circuitry comprising a rate converter, which is adapted to covert the sequence of samples at the fixed sampling rate to the variable sample rate prior to extraction of the digital data therefrom.

74. A data transmitter, comprising:
data modulation circuitry, which is coupled to receive a stream of digital input data and to process the input data so as to generate an output sequence of data samples at a variable sample rate, and which is adapted to negotiate with a receiver over a communication medium so as to set the sample rate and to determine, responsively to the sample rate, a variable symbol rate of an analog data signal to be transmitted by the transmitter, the data modulation circuitry comprising a rate converter, which is adapted to convert the output sequence of data samples to a predetermined, fixed sample rate;
a digital/analog converter (DAC), which is coupled to convert the output sequence of data samples into the analog data signal at the fixed sample rate; and
an analog front end circuit, which is coupled to transmit the analog data signal over the communication medium to the receiver.
